(19) United States
(12) Patent Application Publication
(10) Pub. No.: US 2001/0051253 A1
(43) Pub. Date: Dec. 13, 2001

(54) Female fastener for interlocking with a male fastener

(76) Inventors: Jung-Chi Tai, Tainan Hsien (TW); James Fang, Tainan Hsien (TW); Jackey C.C. Su, Tainan Hsien (TW); Chi-Liang Liang, Tainan Hsien (TW)

Correspondence Address: Timothy J. Keefer, Wildman, Harrold, Allen & Dixon, 225 West Wacker Drive, Chicago, IL, 60606, US

(21) Appl. No.: 09/905,537

(22) Filed: Jul. 13, 2001

(30) Foreign Application Priority Data
Apr. 5, 2000 (TW) 089205379

(51) Int. Cl. B32B 3/30

(52) U.S. Cl. 428/167

(57) ABSTRACT

A female fastener is adapted to interlock with a male fastener, and is formed as a laminate that includes a carding fiber web layer, and an air-laid fiber web layer underlying the carding fiber web layer. The carding fiber web layer is composed of composite fibers having a length of at least 1.5 cm. The air-laid fiber web layer is composed of composite fibers having a length of not more than 10 mm. The carding fiber web layer has a connecting surface adapted to interlock with the male fastener. Optionally, the laminate can further include at least one additional carding fiber web layer.

### BACKGROUND OF THE INVENTION

1. Field of the Invention

The invention relates to a female fastener for interlocking with a male fastener to constitute a hook-and-loop fastener.

2. Description of the Related Art

An interlocking fastener available under the trademark of “VELCRO” is widely used in various applications, such as clothes, shoes, personal sanitary articles (for example, disposable diapers). The VELCRO fastener comprises a male fastener and a female fastener. The male fastener is provided with a plurality of elastic hooks, whereas the female fastener is provided with a plurality of loops. When the male fastener and the female fastener are brought face-to-face and are pressed together, the hooks and the loops will become tangled to create a plurality of mechanical connections. Therefore, the male fastener and female fastener will not separate easily under normal conditions. However, when a sufficient pulling force is applied to separate the male and female fasteners, the hooks could be torn away from the loops because of the elasticity of the hooks. Therefore, the male fastener can separate from the female fastener at this time.

It is known in the art to form the male fastener and the female fastener from woven fabric. During preparation, a plurality of hooks are woven on the surface of the base fabric to form the female fastener, whereas the male fastener is formed by cutting the hooks of the female fastener.

The female fastener can also be made of non-woven fabric. FIG. 1 is a schematic view to illustrate an apparatus for manufacturing a conventional female fastener. Fiber web 10 is conveyed to a set of press rolls 21 through a conveying belt 20. The set of press rolls 21 includes three press rolls 210, 211 and 212, in which the press rolls 210 and 211 have gear wheel surfaces. The fiber web 10 passes between the press rolls 210 and 211, and is pressed by the press rolls 210 and 211 to form the fiber web 10 with a corrugated shape. A meltable film 220 from a die 22, which is located above the press roll set 21, falls down into the gap between the two press rolls 210 and 212, and is laminated with the fiber web 10 to form a laminate. The laminate is roll-pressed by the press roll 210 and the press roll 212, which also serves as a cooling roll. The surface of the laminate facing toward the press roll 212 is flattened by the pressing action of the press roll 212. On the other hand, the surface of the laminate facing toward the press roll 210 maintains its corrugated shape. The film 220 adheres to the fiber web 10 in a melted state. The film 220 is hardened by the cooling action of the press roll 212, and the laminate is wound to form a roll of female fastener. Referring to FIG. 2, the female fastener produced by the conventional method of FIG. 1 includes a top layer 101, which is constructed with the fiber web 10, and a backing film layer 102. Since the backing film layer 102 is formed by a film casting process, it slows down and complicates the manufacturing process and results in increased costs.

### SUMMARY OF THE INVENTION

Therefore, the object of the present invention is to provide a female fastener which is adapted to interlock with a male fastener to constitute a hook-and-loop fastener, and which includes an air-laid fiber web as a backing layer, thereby dispensing with the need for a cast film as a backing layer.

Accordingly, a female fastener of this invention is adapted to interlock with a male fastener to constitute a hook-and-loop fastener, and comprises:

a laminate including a carding fiber web layer, and an air-laid fiber web layer underlying the carding fiber web layer, the carding fiber web layer being composed of composite fibers having a length of at least 1.5 cm, the air-laid fiber web layer being composed of composite fibers having a length of not more than 10 mm, the carding fiber web layer having a connecting surface adapted to interlock with the male fastener.

Optionally, the laminate can further include at least one additional carding fiber web layer.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic side view showing a conventional apparatus for producing a conventional female fastener;

FIG. 2 is a perspective view of the conventional female fastener produced by the apparatus of FIG. 1;

FIG. 3 is a perspective view showing a hook-and-loop fastener that incorporates the female fastener according to this invention;

FIG. 4 is a perspective view of the female fastener according to this invention;

FIG. 5 is a schematic side view showing an apparatus for producing the female fastener according to this invention;

FIG. 6 is a flow diagram showing the components and the process for producing the first preferred embodiment of the female fastener according to this invention;

FIG. 7 is a flow diagram showing the components and the process for producing the second preferred embodiment of the female fastener according to this invention;

FIG. 8 is a flow diagram showing the components and the process for producing the third preferred embodiment of the female fastener according to this invention;

FIG. 9 is a flow diagram showing the components and the process for producing the fourth preferred embodiment of the female fastener according to this invention;

FIG. 10 is a flow diagram showing the components and the process for producing the fifth preferred embodiment of the female fastener according to this invention; and

FIG. 11 is a flow diagram showing the components and the process for producing the sixth preferred embodiment of the female fastener according to this invention.

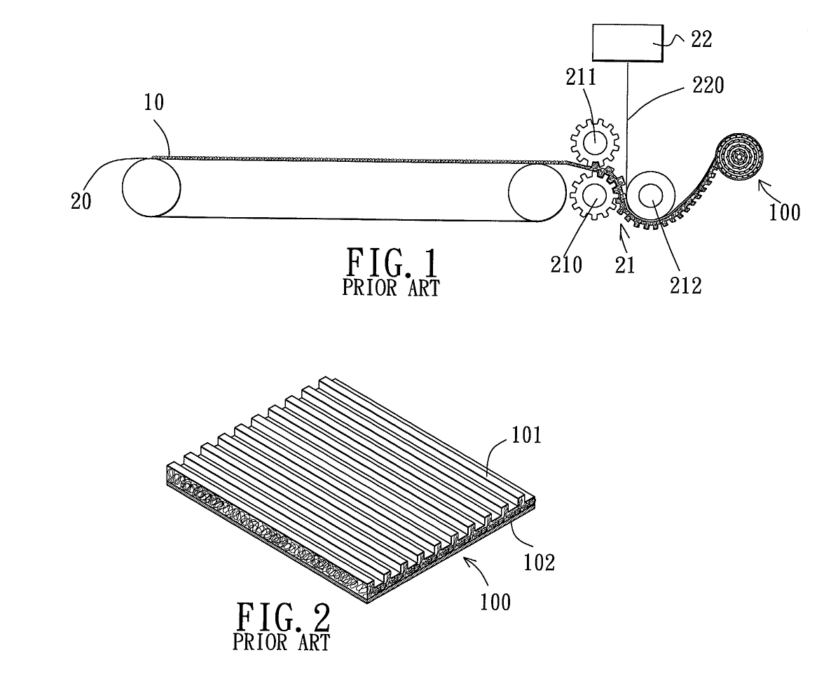

### DETAILED DESCRIPTION OF THE PREFERRED EMBODIMENTS

Before the present invention is described in greater detail with reference to the preferred embodiments, it should be noted that like elements are denoted by the same reference numbers in the following description.

Two types of composite fibers with different lengths are used to produce the female fastener according to this invention. The length of the first composite fiber is at least 1.5 cm, whereas the length of the second composite fiber is not more than 10 mm. Both the first and second composite fibers are made of two polymer components with different melting points. The bicomponent fibers could be in a side-by-side configuration, a sheath-and-core configuration, etc. Since the technology regarding the fabrication of the composite fibers is well known in the art, it will not be further described herein. As used herein, the term “first composite fiber” means a composite fiber with a length of at least 1.5 cm, whereas the term “second composite fiber” means a composite fiber with a length of not more than 10 mm.

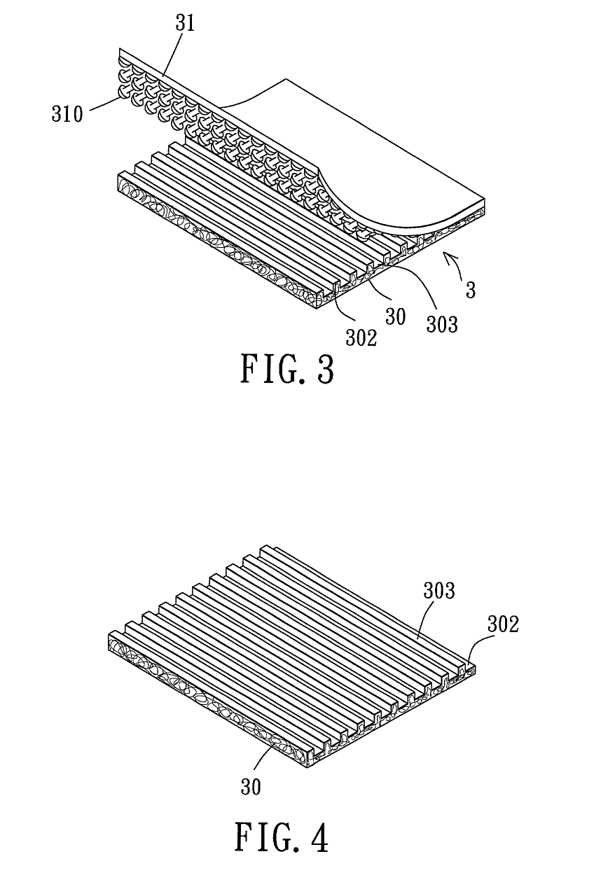

FIG. 3 illustrates a hook-and-loop fastener 3 that includes a female fastener 30 according to this invention and a male fastener 31.

A plurality of flanges 310 are provided on the male fastener 31. The front or free end of each of the flanges 310 could be in the form of a hook or a mushroom head. Of course, other suitable shapes could be recognized by those skilled in the art. As shown in FIG. 3, the front end of each flange 310 of the male fastener 310 is in the shape of a mushroom head. When the male fastener 31 and the female fastener 30 are brought face-to-face and are pressed together, the mushroom heads of the flanges 310 of the male fastener 31 will tangle with the fibers on a connecting surface of the female fastener 30, thereby creating a plurality of mechanical connections. Therefore, the male fastener 31 and the female fastener 30 do not easily separate in the normal state. However, when a sufficient pulling force is applied to separate the male fastener 31 from the female fastener 30, the mushroom heads of the flanges 310 could be torn away from the fibers of the female fastener 30, so that the male fastener 31 and the female fastener 30 can separate from each other. Therefore, the male fastener 31 and the female fastener 30 could be connected and separated repeatedly in the aforesaid way.

Referring to FIG. 4, the female fastener 30 is made of non-woven fabric, and has a first surface and a second surface opposite to the first surface. The first surface defines a longitudinal direction and a transverse direction that is transverse to the longitudinal direction. When the female fastener 30 is thermally pressed by heating press rolls during the production thereof, a plurality of recesses 302 and a plurality of ribs 303 are formed parallel to the transverse direction on the first surface. The recesses 302 and the ribs 303 are arranged alternately, i.e., each of the ribs 303 is formed between an adjacent pair of the recesses 302. In the embodiments of this invention, the press roll that contacts the first surface of the female fastener 30 has a surface with a corrugated configuration. Therefore, when the protruding parts of the press roll come into contact with the first surface of the female fastener 30, a plurality of recesses will be formed on the first surface of the female fastener 30. The areas of the first surface, which do not contact the protruding and the recessed parts of the press roll, will be formed with a plurality of ribs 303 relative to the recesses 302 on the first surface of the female fastener 30. When the male fastener 31 and the female fastener 30 of this invention are brought face-to-face and are pressed together, the mushroom heads of the flanges 310 of the male fastener 31 will be inserted into the recesses 302 of the female fastener 30 and will tangle with the fibers on the connecting surface of the female fastener 30, thereby creating a plurality of mechanical connections.

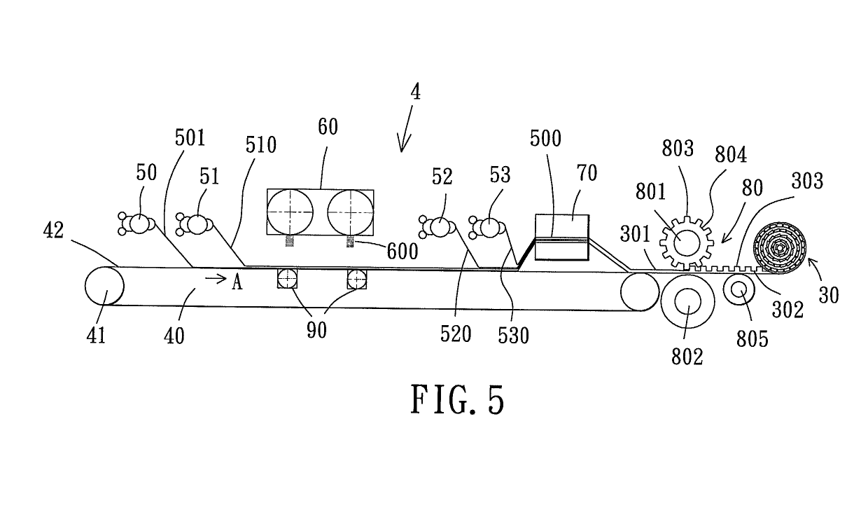

FIG. 5 illustrates an apparatus 4 for producing the female fastener according to this invention. The apparatus 4 has a conveying device 40, which extends along a horizontal direction. The conveying device 40 includes a set of driving rolls 41 and a conveying belt 42, which is provided around and which is driven by the driving rolls 41. The conveying belt 42 proceeds along the direction shown by the arrow (A) in FIG. 5. A first carding device 50, a second carding device 51, a molding device 60, a third carding device 52, a fourth carding device 53, a hot air device 70 and a set of press rolls 80 are provided in sequence along an advancing direction of the conveying belt 42. The set of press rolls 80 includes a first press roll 801, a second press roll 802, and a flat press roll 805. A plurality of suction device 90 are provided under the conveying belt 42 and along the advancing direction of the conveying belt 42. The number of carding devices arranged in the apparatus 4 depends on the number of layers included in the female fastener to be produced.

First Preferred Embodiment

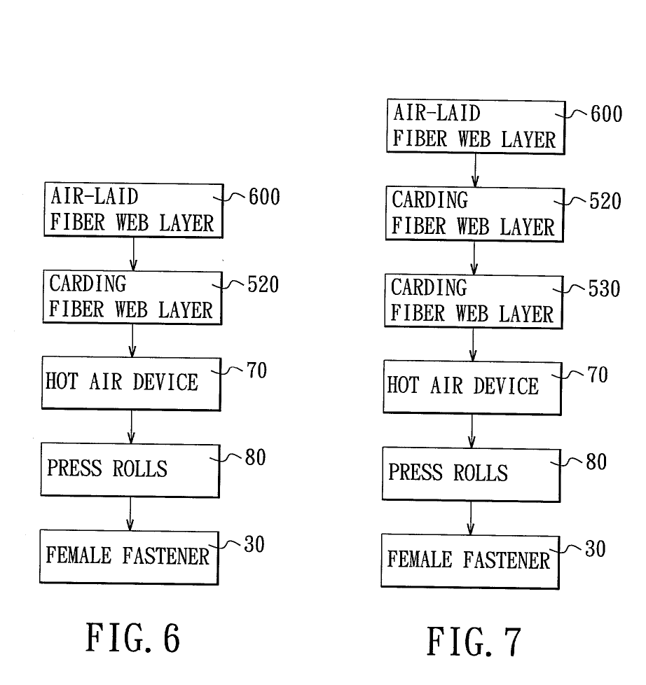

Referring to FIGS. 4, 5 and 6, the second composite fibers (i.e., those with a fiber length not more than 10 mm) are conveyed to the molding device 60 in a well-known manner, and are formed into an air-laid fiber web layer 600 via an air-laid process. The air-laid fiber web layer 600 is conveyed to the conveying belt 42, is held onto the conveying belt 42 by the suction devices 90 located under the conveying belt 42, and then proceeds along the direction shown by arrow (A) in FIG. 5. At the same time, the first composite fibers (i.e., those with a fiber length of at least 1.5 cm) are conveyed to the third carding device 52. After the processes of opening and carding, a carding fiber web layer 520 is laid on the air-laid fiber web layer 600, which is being conveyed on the conveying belt 42, to form a laminate 500. The laminate 500 is conveyed into the hot air device 70 by the conveying belt 42. The temperature set in the hot air device 70 is sufficient to melt the first composite fibers or the second composite fibers which have a lower melting point. The composite fibers having a higher melting point are fused together by the melted fibers after the laminate 500 passes through the hot air device 70. The laminate 500 from the hot air device 70 is then conveyed through the gap between the first press roll 801 and the second press roll 802. The surface of the first press roll 801 has a corrugated configuration, i.e., in the form of a gear wheel. The second press roll 802 is provided with a flat surface. The surfaces of the first press roll 801 and the second press roll 802 are heated in a known manner. The opposing surfaces of the laminate 500 are thermally pressed by the press rolls 801 and 802 when the laminate 500 passes through the gap between the press rolls 801 and 802. As used herein, the surface of the laminate 500 in contact with the first press roll 801 is defined as the first surface, whereas the surface of the laminate 500 in contact with the second press roll 802 is defined as the second surface. When the protruding parts 803 of the first press roll 801 come into contact with the first surface, a plurality of recesses 302 are formed on the first surface. The recessed parts 804 of the first press roll 801 do not contact the first surface. As such, a plurality of ribs 303 are formed on the first surface, relative to the recesses 302. Because the protruding parts and the recessed parts of the first press roll 801 are arranged alternately, the recesses 302 and the ribs 303 are also arranged alternately on the first surface of the laminate 500. As shown in FIG. 5, the flat press roll 805 is provided adjacent to the press rolls 801 and 802. The surface of the flat press roll 805 is also heated in a known manner. The second surface of the laminate 500 is thermally pressed by the flat press roll 805 to form a smooth surface after the laminate 500 presses through the press rolls 801 and 802. The smooth surface could be printed with markings as required. The female fastener 30 of this invention is produced after the laminate 500 is thermally pressed by the set of press rolls 80. Then, the female fastener 30 is wound to form a roll. The female fastener 30 of this embodiment is shown in FIG. 4.

Second Preferred Embodiment

Referring to FIGS. 4, 5 and 7, the second composite fibers (i.e., those with a fiber length not more than 10 mm) are conveyed to the molding device 60 in a well-known manner, and are formed into an air-laid fiber web layer 600 via the air-laid process. The air-laid fiber web layer 600 is conveyed to the conveying belt 42, is held onto the conveying belt 42 by the suction devices 90 located under the conveying belt 42, and then proceeds along the direction shown by arrow (A) in FIG. 5. At the same time, the first composite fibers (i.e., those with a fiber length of at least 1.5 cm) are conveyed to the third carding device 52 and the fourth carding device 53. After the processes of opening and carding, carding fiber web layers 520 and 530 are laid on the air-laid fiber web layer 600 being conveyed on the conveying belt 42, in which the carding fiber web layer 520 from the third carding device 52 overlies the air-laid fiber web layer 600, and the carding fiber web layer 530 from the fourth carding device 53 overlies the carding fiber web layer 520, to form a laminate 500. Then, the laminate 500 is processed by the hot air device 70 and the set of press rolls 80 to form the female fastener 30 of FIG. 4 in a manner similar to that in the first preferred embodiment.

Third Preferred Embodiment

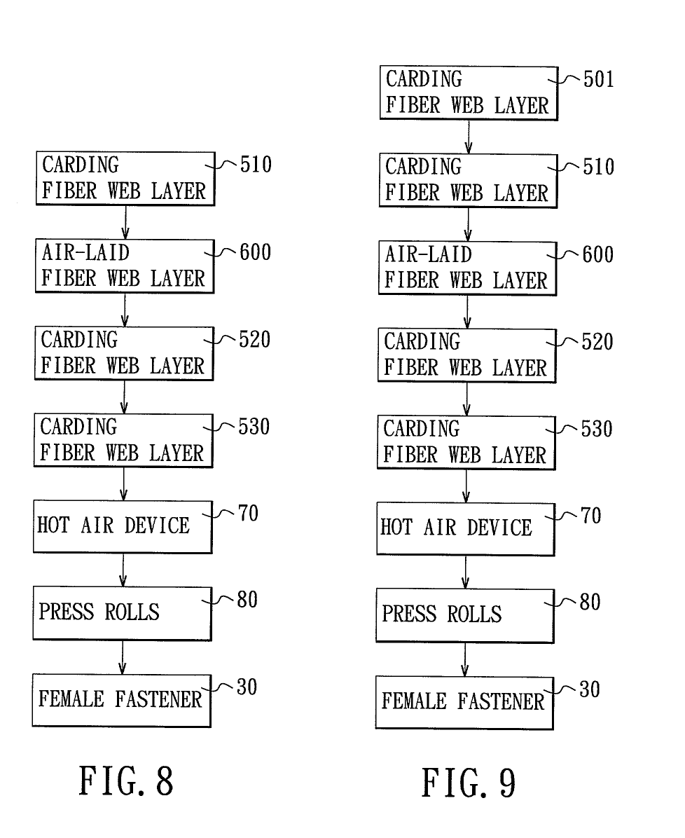

Referring to FIGS. 4, 5 and 8, the first composite fibers (i.e., those with a fiber length of at least 1.5 cm) are conveyed to the second carding device 51 in a well-known manner. After the processes of opening and carding, a carding fiber web layer 510 is laid on the conveying belt 42. The second composite fibers (i.e., those with a fiber length not more than 10 mm) are conveyed to the molding device 60 in a well-known manner, and are formed into an air-laid fiber web layer 600 via the air-laid process. The air-laid fiber web layer 600 is conveyed to the conveying belt 42, so as to be held onto the conveying belt 42 by the suction devices 90 located under the conveying belt 42, and is laid on the carding fiber web layer 510. At the same time, the first composite fibers (i.e., those with a fiber length of at least 1.5 cm) are conveyed to the third carding device 52 and the fourth carding device 53 in a well-known manner. After the processes of opening and carding, carding fiber web layers 520 and 530 are laid on the air-laid fiber web layer 600 being conveyed on the conveying belt 42, in which the carding fiber web layer 520 from the third carding device 52 overlies the air-laid fiber web layer 600, and the carding fiber web layer 530 from the fourth carding device 53 overlies the carding fiber web layer 520, to form a laminate 500. Then, the laminate 500 is processed by the hot air device 70 and the set of press rolls 80 to form the female fastener 30 of FIG. 4 in a manner similar to that in the first preferred embodiment.

Fourth Preferred Embodiment

Referring to FIGS. 4, 5 and 9, the first composite fibers (i.e., those with a fiber length of at least 1.5 cm) are conveyed to the first carding device 50 and the second carding device 51 in a well-known manner. After the processes of opening and carding, carding fiber web layers 501 and 510 are laid on the conveying belt 42, in which the carding fiber web layer 510 from the second carding device 51 overlies the carding fiber web layer 501 from the first carding device 50. The second composite fibers (i.e., those with a fiber length not more than 10 mm) are conveyed to the molding device 60 in a well-known manner, and are formed into an air-laid fiber web layer 600 via the air-laid process. The air-laid fiber web layer 600 is conveyed to the conveying belt 42, so as to be held onto the conveying belt 42 by the suction devices 90 located under the conveying belt 42, and is laid on the carding fiber web layer 510. At the same time, the first composite fibers (i.e., those with a fiber length of at least 1.5 cm) are conveyed to the third carding device 52 and the fourth carding device 53 in a well-known manner. After the processes of opening and carding, carding fiber web layers 520 and 530 are laid on the air-laid fiber web layer 600 being conveyed on the conveying belt 42, in which the carding fiber web layer 520 from the third carding device 52 overlies the air-laid fiber web layer 600, and the carding fiber web layer 530 from the fourth carding device 53 overlies the carding fiber web layer 520, to form a laminate 500. Then, the laminate 500 is processed by the hot air device 70 and the set of press rolls 80 to form the female fastener 30 of FIG. 4 in a manner similar to that in the first preferred embodiment.

Fifth Preferred Embodiment

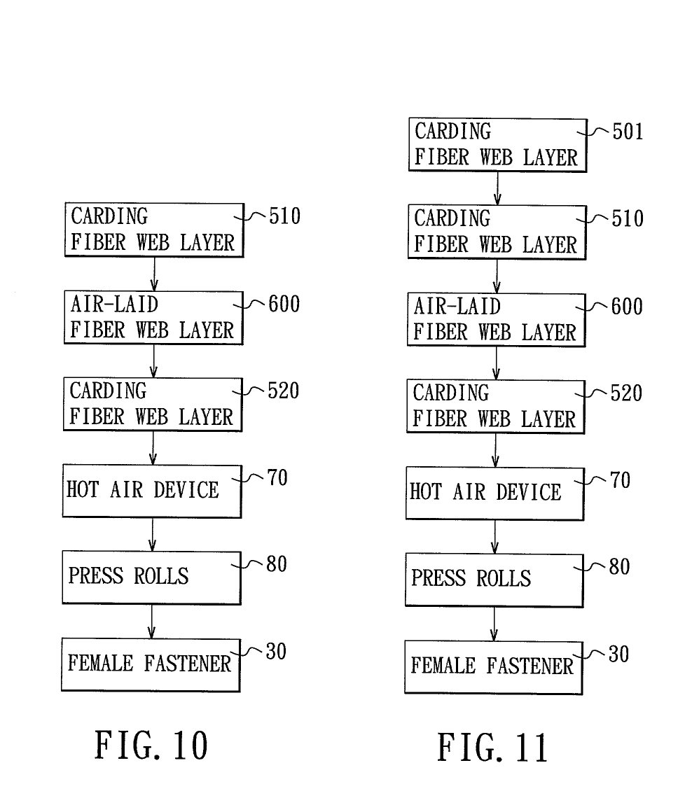

Referring to FIGS. 4, 5 and 10, the first composite fibers (i.e., those with a fiber length of at least 1.5 cm) are conveyed to the second carding device 51 in a well-known manner. After the processes of opening and carding, a carding fiber web layer 510 is laid on the conveying belt 42. The second composite fibers (i.e., those with a fiber length not more than 10 mm) are conveyed to the molding device 60 in a well-known manner, and are formed into an air-laid fiber web layer 600 via the air-laid process. The air-laid fiber web layer 600 is conveyed to the conveying belt 42, so as to be held onto the conveying belt 42 by the suction devices 90 located under the conveying belt 42, is laid on the carding fiber web layer 510, and then proceeds along the direction shown by arrow (A) in FIG. 5. At the same time, the first composite fibers (i.e., those with a fiber length of at least 1.5 cm) are conveyed to the third carding device 52 in a well-known manner. After the processes of opening and carding, a carding fiber web layer 520 is laid on the air-laid fiber web layer 600 being conveyed on the conveying belt 42 to form a laminate 500. Then, the laminate 500 is processed by the hot air device 70 and the set of press rolls 80 to form the female fastener 30 of FIG. 4 in a manner similar to that in the first preferred embodiment.

Sixth Preferred Embodiment

Referring to FIGS. 4,5 and 11, the first composite fibers (i.e., those with a fiber length of at least 1.5 cm) are conveyed to the first carding device 50 and the second carding device 51 in a well-known manner. After the processes of opening and carding, carding fiber web layers 501 and 510 are laid on the conveying belt 42, in which the carding fiber web layer 510 from the second carding device 51 overlies the carding fiber web layer 501 from the first carding device 50. The second composite fibers (i.e., those with a fiber length not more than 10 mm) are conveyed to the molding device 60 in a well-known manner, and are formed into an air-laid fiber web layer 600 via the air-laid process. The air-laid fiber web layer 600 is conveyed to the conveying belt 42, so as to be held onto the conveying belt 42 by the suction devices 90 located under the conveying belt 42, is laid on the carding fiber web layer 510, and then proceeds along the direction shown by arrow (A) in FIG. 5. At the same time, the first composite fibers (i.e., those with a fiber length of at least 1.5 cm) are conveyed to the third carding device 52 in a well-known manner. After the processes of opening and carding, a carding fiber web layer 520 is laid on the air-laid fiber web layer 600 being conveyed on the conveying belt 42 to form a laminate 500. Then, the laminate 500 is processed by the hot air device 70 and the set of press rolls 80 to form the female fastener 30 of FIG. 4 in a manner similar to that in the first preferred embodiment.

It has thus been shown that the female fastener 30 according to this invention includes an air-laid fiber web layer 600 (which is composed of composite fibers having a fiber length of not more than 10 mm) and at least one carding fiber web layer 501, 510, 520 and 530 (which is composed of composite fibers having a fiber length of at least 1.5 cm). As compared to the carding fiber web layer 501, 510, 520 and 530, the air-laid fiber web layer 600 is a dense layer, which enables the laminate 500 to be held onto the conveying belt 42 by the suction devices 90. Since the air-laid fiber web layer 600 is formed as a backing layer on the conveying belt 42 together with the carding fiber web layer, no additional step of film casting for forming a backing film layer is necessary in the manufacture of the female fastener 30 according to the present invention. The air-laid fiber web layer 600 is critical to the automated process for producing the female fastener 30 according to this invention. Without the an air-laid fiber web layer 600, the carding fiber web layers 501, 510, 520 and 530 cannot be held onto the conveying belt 42 by the suction devices 90 because of the bigger pores therein.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A female fastener for interlocking with a male fastener, comprising a laminate including a first carding fiber web layer, and an air-laid fiber web layer underlying said first carding fiber web layer, said first carding fiber web layer being composed of composite fibers having a length of at least 1.5 cm, said air-laid fiber web layer being composed of composite fibers having a length of not more than 10 mm, said first carding fiber web layer having a connecting surface adapted to interlock with the male fastener.

2. The female fastener of claim 1, wherein said connecting surface includes a plurality of recesses and a plurality of ribs formed between adjacent ones of said recesses.

3. The female fastener of claim 2, wherein said recesses and said ribs are alternately provided along a longitudinal direction of said laminate.

4. The female fastener of claim 2, wherein said laminate further includes a second carding fiber web layer between said first carding fiber web layer and said air-laid fiber web layer, said second carding fiber web layer being composed of fibers having a length of at least 1.5 cm.

5. The female fastener of claim 4, wherein said laminate further includes a third carding fiber web layer underlying said air-laid fiber web layer, said third carding fiber web layer being composed of composite fibers having a length of at least 1.5 cm.

6. The female fastener of claim 5, wherein said laminate further includes a fourth carding fiber web layer underlying said third carding fiber web layer, said fourth carding fiber web layer being composed of composite fibers having a length of at least 1.5 cm.

7. The female fastener of claim 2, wherein said laminate further includes a second carding fiber web layer underlying said air-laid fiber web layer, said second carding fiber web layer being composed of composite fibers having a length of at least 1.5 cm.

8. The female fastener of claim 7, wherein said laminate further includes a third carding fiber web layer underlying said air-laid fiber web layer, said third carding fiber web layer being composed of composite fibers having a length of at least 1.5 cm.
